(19) United States
(12) Patent Application Publication
(10) Pub. No.: US 2024/0249270 A1
(43) Pub. Date: Jul. 25, 2024

(54) SYSTEMS AND METHODS FOR SECURE TRANSMISSION OF PAYMENT DATA

(71) Applicant: JPMORGAN CHASE BANK, N.A., New York, NY (US)

(72) Inventor: Raman SANKARAN, Garnet Valley, PA (US)

(21) Appl. No.: 18/158,804

(22) Filed: Jan. 24, 2023

(51) Int. Cl. G06Q 20/22; G06Q 20/40

(52) U.S. Cl. CPC G06Q 20/227; G06Q 20/40

(57) ABSTRACT

In some aspects, the techniques described herein relate to a method including: receiving, at an issuer backend and from a merchant backend, a token and a request for a payment option; executing a query against a database, wherein the query uses the token as a lookup key, and wherein the query returns an account number and customer details, wherein the customer details are associated with a customer that is associated with the account number; generating the payment option based on a payment product associated with the account number and the customer details; sending the payment option to the merchant backend; receiving, from the merchant backend, a transaction identifier and an indication to apply the payment to a transaction associated with the transaction identifier; applying the payment option with respect to an invoice associated with the payment product.

### BACKGROUND

### 1. Field of The Invention

Aspects generally relate to systems and methods for secure transmission of payment data.

### 2. Description of the Related Art

Payment product issuers, and merchants having an online presence, may desire to cooperate in offering advanced payment options to overlapping customers. Such advanced payment options may be customized and offered on a per-customer basis based on, and/or associated with, a customer's payment product. A customer's payment product may be the only readily available data point that links the customer to both the merchant and the payment product issuer. A merchant may send a customer's payment product information to a payment product issuer as a customer identifier, so that the payment product issuer may return customized payment scenarios for the customer. Transmission of a customer's payment product information over a public network, however, is a sever security risk and a liability for the organizations involved. Moreover, maintaining a separate substitute reference for every payment product account number that is used with every merchant to prevent sending of actual account numbers would result in massive storage, processing, and relational overhead with respect to an issuing organizations backend technology infrastructure.

### SUMMARY

In some aspects, the techniques described herein relate to a method including: receiving, at a merchant backend, payment details including an account number and an instruction to store the payment details, wherein the account number is for a payment product; sending, by the merchant backend, the account number to a payment network backend; receiving, from the payment network backend, a token, wherein the token is mapped to the account number; sending, by the merchant backend, a communication to an issuer backend, wherein the communication includes a request for a payment option and the token; receiving, by the merchant backend, the payment option; receiving, by the merchant backend, an indication to use the payment option with respect to a transaction; and sending the indication to use the payment option and details of the transaction to the issuer backend.

In some aspects, the techniques described herein relate to a method, including: displaying the payment option via a frontend computer application executing on an electronic device.

In some aspects, the techniques described herein relate to a method, wherein the payment option is selectable by a user of the electronic device.

In some aspects, the techniques described herein relate to a method, wherein the payment option is displayed in association with the transaction.

In some aspects, the techniques described herein relate to a method, wherein the indication to use the payment option with respect to the transaction is received from the electronic device.

In some aspects, the techniques described herein relate to a method, wherein the indication to use the payment option with respect to the transaction is received as a call by the frontend computer application executing on the electronic device to an API method exposed by the merchant backend.

In some aspects, the techniques described herein relate to a method, wherein the indication to use the payment option is received as a parameter of the API method exposed by the merchant backend.

In some aspects, the techniques described herein relate to a system including at least one computer including a processor and a memory, wherein the at least one computer is configured to: receive payment details including an account number and an instruction to store the payment details, wherein the account number is for a payment product; send the account number to a payment network backend; receive, from the payment network backend, a token, wherein the token is mapped to the account number; send a communication to an issuer backend, wherein the communication includes a request for a payment option and the token; receive the payment option; receive an indication to use the payment option with respect to a transaction; and send the indication to use the payment option and details of the transaction to the issuer backend.

In some aspects, the techniques described herein relate to a system, including: displaying the payment option via a frontend computer application executing on an electronic device.

In some aspects, the techniques described herein relate to a system, wherein the payment option is selectable by a user of the electronic device.

In some aspects, the techniques described herein relate to a system, wherein the payment option is displayed in association with the transaction.

In some aspects, the techniques described herein relate to a system, wherein the indication to use the payment option with respect to the transaction is received from the electronic device.

In some aspects, the techniques described herein relate to a system, wherein the indication to use the payment option with respect to the transaction is received as a call by the frontend computer application executing on the electronic device to an API method exposed by a merchant backend.

In some aspects, the techniques described herein relate to a system, wherein the indication to use the payment option is received as a parameter of the API method exposed by the merchant backend.

In some aspects, the techniques described herein relate to a non-transitory computer readable storage medium, including instructions stored thereon, which instructions, when read and executed by one or more computer processors, cause the one or more computer processors to perform steps including: receiving, at a merchant backend, payment details including an account number and an instruction to store the payment details, wherein the account number is for a payment product; sending, by the merchant backend, the account number to a payment network backend; receiving, from the payment network backend, a token, wherein the token is mapped to the account number; sending, by the merchant backend, a communication to an issuer backend, wherein the communication includes a request for a payment option and the token; receiving, by the merchant backend, the payment option; receiving, by the merchant backend, an indication to use the payment option with respect to a transaction; and sending the indication to use the payment option and details of the transaction to the issuer backend.

In some aspects, the techniques described herein relate to a non-transitory computer readable storage medium, including: displaying the payment option via a frontend computer application executing on an electronic device.

In some aspects, the techniques described herein relate to a non-transitory computer readable storage medium, wherein the payment option is selectable by a user of the electronic device.

In some aspects, the techniques described herein relate to a non-transitory computer readable storage medium, wherein the payment option is displayed in association with the transaction.

In some aspects, the techniques described herein relate to a non-transitory computer readable storage medium, wherein the indication to use the payment option with respect to the transaction is received from the electronic device.

In some aspects, the techniques described herein relate to a non-transitory computer readable storage medium, wherein the indication to use the payment option with respect to the transaction is received as a call by the frontend computer application executing on the electronic device to an API method exposed by the merchant backend; and wherein the indication to use the payment option is received as a parameter of the API method exposed by the merchant backend.

In some aspects, the techniques described herein relate to a method, including: receiving, at an issuer backend and from a merchant backend, a token and a request for a payment option; executing a query against a database, wherein the query uses the token as a lookup key, and wherein the query returns an account number and customer details, wherein the customer details are associated with a customer that is associated with the account number; generating the payment option based on a payment product associated with the account number and the customer details; sending the payment option to the merchant backend; receiving, from the merchant backend, a transaction identifier and an indication to apply the payment option to a transaction associated with the transaction identifier; and applying the payment option with respect to an invoice associated with the payment product.

### BRIEF DESCRIPTION OF THE DRAWINGS

FIG. 1 is a block diagram of a system for secure transmission of payment data, in accordance with aspects.

FIG. 2 is a logical flow for secure transmission of payment data, in accordance with aspects.

FIG. 3 is a logical flow for secure transmission of payment data, in accordance with aspects.

FIG. 4 is a block diagram of a computing device for implementing certain aspects of the present disclosure.

### DETAILED DESCRIPTION

Aspects generally relate to systems and methods for secure transmission of payment data. Systems and methods described herein facilitate the use of a standardized account number token in communications and lookups with respect to customized payment options generated for customers of a payment product issuing organization. The techniques described herein obviate the storage, relational, and processing overhead that accompanies maintaining separate substitute reference for merchants that accept payment products in electronic payment processes. A single token that may be generated by, or provided to, a payment product issuer, may instead be used, thereby greatly reducing technical spend while preventing payment product account numbers from being repeatedly transmitted between organizations' technology backend infrastructures.

Today, many merchants offer online purchasing and online payment for purchases. So called eCommerce organizations generally accept card-based payment methods such as debit and credit cards, and other payment products that include standardized payment information associated therewith, and that may or may not be associated with a physical payment card. For convenience, online merchants often offer to digitally store a customer's payment details, including an account number of the customer's payment product, on the merchants' servers. This storage allows the payment details to be easily retrieved by the customer instead of being repeatedly typed into a webform by the customer at every purchase from the merchant.

Account numbers for payment products generally conform to industry standard formats and are provided by payment network organizations. A payment network organization provides a digital network, sometime known as “payment rails” over which payment transactions are accepted from online merchants and routed to payment product issuing organizations. Payment network organizations work with payment product issuers to provide account numbers, and other payment information, in a standardized format for processing over their payment networks.

Payment product issuing organizations provide the credit facilities, demand deposit accounts (DDAs), and services that are associated with funding payments that are charged to an issued payment product. Often, payment product issuers also manage the disbursement of cards having the standardized account number and other payment information printed on the physical card. The cards can be used for in-person transactions with card reading point-of-sale equipment but are also used by the card owners as a reference for retrieval of the account number and other payment information printed on the physical card.

Due to regulatory mandates in different jurisdictions and the risk of, and liability inherent in, data breaches with respect to sensitive payment information, payment product account number tokenization has become popular. Payment product account number (e.g., credit card and debit card number) tokenization includes the process of replacing sensitive payment data with randomized substitute data. The substitute data acts as a placeholder, and a lookup key, for the more sensitive data that it substitutes for. An exemplary token may be a randomly generated string of numbers or an alpha-numeric string, or any other randomly generated sequence of characters. The string may be generated by using a payment product account number as input to a one-way (i.e., a hashing) function, where the output is the tokenized account number.

Online merchants, digital wallets, and other organizations or systems that store payment information can store tokens generated from payment product account numbers instead of storing the actual account numbers, themselves. Mappings from a token to its related account number may then be stored by payment processing organizations and by payment product issuers in highly secure storage databases sometimes referred to as “vaults.” The tokenization process allows merchants, digital wallets, and others to store benign tokens that conveniently allow a customer to elect to store payment product information on a merchant's systems. In the event of a data breach, however, the tokens cannot be used for payments without the corresponding mappings. Accordingly, this process keeps a merchant's customer's payment data safe and highly available while lowering liability for the merchants storing the data.

As noted above, payment network organizations and payment product issuing organizations may work together to facilitate electronic payments using a payment product that is issued and serviced by the issuing organization, and that uses the payment network organization's payment rails in payment transactions. When a credit product is issued, a standardized account number is generated and associated with a payment product and with a customer that is the owner of the payment product. A payment network organization or a payment product issuer may generate the account number and may generate a token of the account number by using a one-way function. Both the payment network organization and the payment product issuer may store the account number and the associated token in a secure data base on their respective technology infrastructure backends.

When a customer inputs payment product information, including a payment product account number into a merchant's website and instructs the merchant to store the payment information, the merchant may send the payment product account number to the payment network organization that provided the account number (instead of storing the account number). This may be done by calling a method exposed by an API of the payment network organization and passing the account number as a parameter of the method. The transmission may be encrypted so that the account number is not passed in clear text over a public network, such as the internet.

The payment network organization that issued, or is associated with, the payment product account number (the account number) may keep a mapping of the account number to a tokenized version of the account number (a token). This mapping may be stored in a secure database or “vault” in a technology infrastructure backend of the payment network organization (e.g., in a datacenter of the payment network organization). Upon receipt of an account number from a merchant, the payment network organization may query the vault using the account number as a lookup key, and the query may return the related token. The payment network organization may generate a return communication to the merchant that includes the token, and the merchant may store the token on the merchant's backend technology infrastructure, instead of storing the sensitive account number. Thereafter, the merchant may use the token as an effective substitute for the customer's account number, since both the payment network organization and the payment product provider store mappings from the token to the actual account number.

In accordance with aspects, a merchant may transmit a token to a payment product issuer, and the payment product issuer may use the token as a customer identifier to determine a customized payment offer that the merchant can display, and that the customer can select in an online checkout process. A merchant may transmit a token to a technology infrastructure backend of a payment product issuer using, for example, an API method exposed by the payment product issuer. The API method may take a token as a parameter. Upon receipt of the token the payment product issuer may query a database using the token as a lookup key. The query may return an account number and a customer identifier (customer ID) of a customer that owns the payment product associated with the account number and token.

In accordance with aspects, a payment product provider may provide alternative payment options to its customers. Alternative payment options may be, e.g., an installment payment plan that allows customers to spread payment for a purchase over two or more invoice cycles of the customer's payment product. For instance, if a customer makes a qualifying purchase, the purchase amount may be divided into a number of smaller payment amounts and each of the smaller payment amounts may be added to different invoices for the customer's payment product. What constitutes a qualifying purchase, and how many invoices the customer is allowed to spread the total payment over may be customer specific, and may be determined based on the customer's credit product, the customer's credit worthiness, the customer's available credit with respect to the payment product, etc. A payment product issuer may provide a decisioning engine that takes these and other variables as input and generates an alternative payment offer as output.

In accordance with aspects, a payment product provider may generate a return communication to a merchant as a response to receiving a token from the merchant (e.g., a response to the merchant's API call to the issuer's systems). The return communication may include an alternative payment option in a predefined format. The alternative payment option may also include a customer ID and/or a token. Alternatively, if the communication channel and protocol is synchronous, the merchant backend systems may be waiting on a response to a communication channel and may hold the customer ID in a context of a stateful communication.

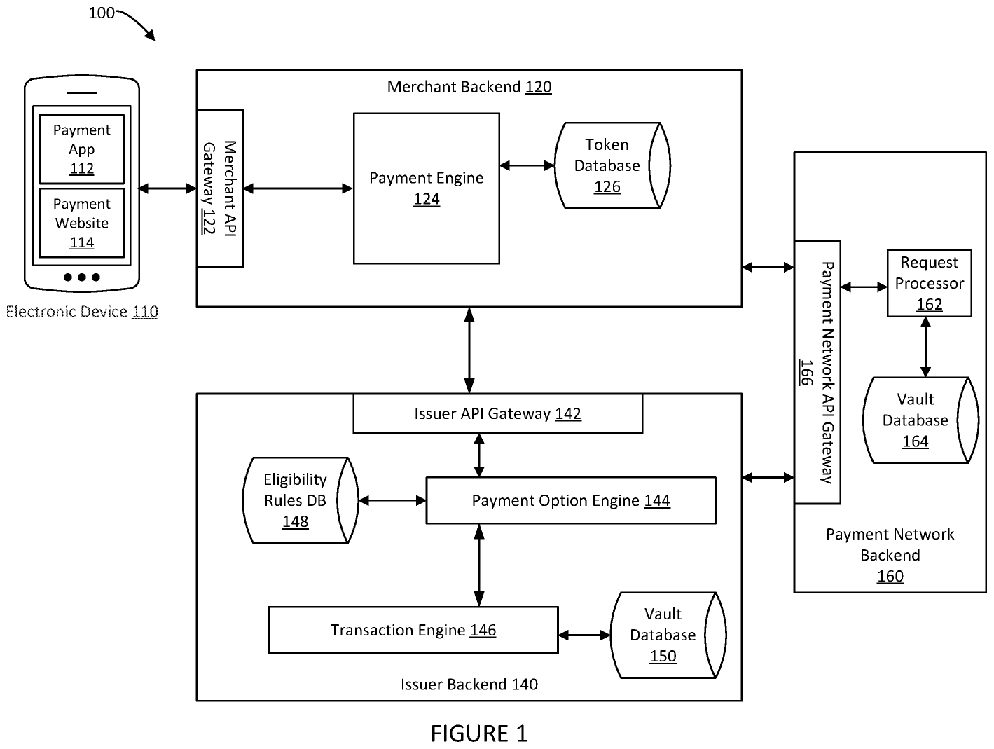

FIG. 1 is a system for secure transmission of payment data, in accordance with aspects. System 100 includes electronic device 110, merchant backend 120, issuer backend 140 and payment network backend 160. Electronic device 110 may be a smart phone, a tablet computer, a laptop computer, or any mobile electronic device that is capable of storing and executing a computer application such as a mobile application and/or internet browser application.

Electronic device 110, merchant backend 120 (including merchant API gateway 122), issuer backend 140, and payment network backend 160 may each be communicatively coupled to a public network, such as the internet, with appropriate hardware and software. Communication and data transmission may take place between these components and subsystems thereof over the public network. For instance, electronic device 110 can include a wired or wireless network interface card (NIC) that interfaces with the public network and is configured with appropriate communication protocols. Likewise, merchant backend 120, issuer backend 140, and payment network backend 160 may include hardware (NICs, switches, routers, etc.) configured with appropriate protocols for intercommunication with each other and with electronic device 110 over the public network.

Merchant backend 120, issuer backend 140, and payment network backend 160 represent the backend technology infrastructures of a merchant organization, a payment product issuing organization, and a payment network organization, respectively. These technology infrastructures include servers, computers, software applications, computer network mediums, and computer networking hardware and software for providing electronic services based on computer software applications executing on requisite hardware. Exemplary hardware and software include webservers, application servers, database servers and database engines, communication servers such as email servers and SMS servers, network routers, switches and firewalls, custom-developed software applications (i.e., computer applications) including hardware to execute such applications on, etc.

Electronic device 110 is depicted displaying payment app 112 and payment website 114 on an interface of electronic device 110 (e.g., a touchscreen interface). Payment app 112 and payment website 114 are computer applications. Payment app 112 may be provided by a merchant organization that owns and/or controls merchant backend 120. Payment app 112 may be in operative communication with merchant backend 120 via merchant API gateway 122. Payment website 114 is a webpage displayed via an internet browsing application executed by electronic device 110. A web server (not shown) executing on merchant backend 120 may serve/publish a payment website that an internet browser can retrieve and display. The served payment website may be configured to allow payment functionality via a web browser. Payment app 112 and payment website 114 may act as frontend interfaces to payment functionality and logic that is provided as a service via merchant backend 120 and subcomponents thereof.

Merchant backend 120 includes payment engine 124 and token database 126. Payment engine may include and execute logic for carrying out payment related tasks. A customer of a merchant organization associated with merchant backend 120 may interact with merchant backend 120 via payment app 112 and/or payment website 114. For instance, a customer may initiate payment for a transaction through payment website 114 and/or payment app 112. The customer may transmit payment product details, including an account number, to payment engine 124 via merchant API gateway 122, and may further transmit an instruction for merchant backend 120 to store the payment product details. The transmission may be via an API method call, such as a payment method, that is exposed by merchant API gateway 122. The payment details and other data may be included as parameters of the called methods.

In accordance with aspects, systems described herein may provide one or more application programming interfaces (APIs) in order to facilitate communication with related/provided applications and/or among various public or partner technology backends, data centers, or the like. APIs may publish various methods and expose the methods via API gateways. A published API method may be called by an application that is authorized to access the published API methods. API methods may take data as one or more parameters of the called method. API access may be governed by an API gateway associated with a corresponding API. Incoming API method calls may be routed to an API gateway and the API gateway may forward the method calls to internal API servers that may execute the called method, perform processing on any data received as parameters of the called method, and send a return communication to the method caller via the API gateway. A return communication may also include data based on the called method and its data parameters.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

Payment engine 124 may receive the payment details from the API call made by electronic device 110. As used herein, “payment details” or “payment information” may include a payment product account number, a customer name associated with the payment product, an expiration date printed on a physical card associated with the account number or otherwise associated with the account number or payment product, and a card verification value (CVV) code that is printed on a physical card associated with the account number. Other data may be included as payment data as is necessary or desired. The communication received by payment engine 124 may include an indication to store some or all of the received payment details. Upon receipt of an indication to store the payment details, payment engine 124 may generate a communication to payment network backend 160, which may be an API method call to payment network API gateway 166. The API call may include the received account number and may request a token that is mapped to the account.

Request processor 162 may receive the account number from payment network API gateway 166 and may query vault database 164. Vault database 164 may store tokens with mappings to payment product account numbers. Vault database 164 may be a secure datastore. Vault database 164 may be any suitable datastore, such as a relational database, a key-value datastore, etc. The query may include the account number as a lookup key and may return the token that is associated with the received account number. Request processor 162 may then generate a return communication to payment engine 124 including the token that is associated with the received account number. Upon receipt of the token via the return communication from request processor 162, payment engine 124 may store the token and other received payment details in token database 126. The token and other payment details may be stored with a relation to a customer ID of a customer associated with the payment details, for lookup purposes. Thereafter, payment engine 124 may use the token as a substitute for the account number in transactions initiated by the customer associated with the account number/token.

In accordance with aspects, issuer backend 140 may include issuer API gateway 142, payment option engine 144, eligibility rule database 148, transaction engine 146 and vault database 150. Vault database 150 may also store tokens with mappings to payment product account numbers and other payment details. Payment network backend 160 and issuer backend 140 may synchronize vault database 164 and vault database 150 to ensure that both organizations have accurate account number to token mappings for payment products issued by the issuing organization associated with issuer backend 140. Accordingly, payment engine 124 can use a token stored in token database 126 as a substitute in communications with issuer backend 140. Issuer backend 140 will be able to us a token received from payment engine 124 to lookup an account number and customer account data associated therewith.

In accordance with aspects, payment engine 124 may send a communication to issuer backend 140 via issuer API gateway 142 (e.g., via an API method call exposed by issuer API gateway 142), including a token. The communication may also request a payment option for the customer related to the token. Payment option engine 144 may receive the token, and transaction engine 146 may use the token as a lookup parameter in a query of vault database 150, to retrieve an account number associated with the token, and other payment details related to the account number/token, such as a customer account and customer details, a payment product associated with the customer account and the account number, an amount of credit available with respect to the payment product, a credit worthiness or credit score of the customer, etc.

Payment details retrieved by transaction engine 146 may be sent to payment option engine 144 and may be used in generation of a payment option for an associated customer. For instance, payment option engine 144 may use eligibility rules stored in eligibility rule database 148 and associated with a payment product that is owned by or associated with a customer as partial input to determine an alternative payment option for the customer. Payment option engine 144 may take customer information that is retrieved from an issuer's systems of record, customer databases, and other sources (not shown in FIG. 1) and combine them with eligibility rules queried from eligibility rule database 148 to determine an alternative payment option.

In accordance with aspects, payment option engine 144 may determine one or more alternative payment options available based on a customer's payment product, and then may determine which of the available alternative payment options the particular customer is eligible for. For instance, payment option engine 144 may take the customer's amount of credit available with respect to the payment product, a credit worthiness or credit score of the customer, and other customer-specific information as input and determine a custom payment option for the customer. Payment option engine 144 may include machine learning models and other algorithms/rules that generate a customized payment option for the customer. A customized payment option may include an installment plan that allows the cost of a good or service to be distributed over two or more invoices of an associated payment product.

Once a payment option has been generated for a customer, payment option engine 144 may send the payment option to payment engine 124 of merchant backend 120. As noted above, this may be in response to a communication, e.g., an API method call, from payment engine 124 that requests a payment option for a customer and passes payment details including a token to payment option engine 144. The communication from payment engine 124 to payment option engine 144 may, in turn, be initiated by receipt of a communication from electronic device 110 and through payment app 112 or payment website 114 that is initiated by a customer using electronic device 110.

Upon receipt of a payment option from payment option engine 144, payment engine 124 may format the terms of the payment option for display via payment app 112 or payment website 114 and may present the payment option to the customer. Payment app 112 and/or payment website 114 may present the payment option as a selectable option to the customer during a payment process. If the customer selects the payment option, the selection may be communicated to payment engine 124 (e.g., via a method call exposed by merchant API gateway 122). Upon receipt of an indication that the customer has selected to use the presented payment option, payment engine 124 may communicate the indication to payment option engine 144. This may be via another API method call to issuer API gateway 142. The payment option usage communication may include the indication to use the generated payment option, a payment amount (e.g., a dollar amount of the transaction that will be charged to the relevant payment product), and a transaction identifier.

Upon receipt of the payment option usage communication, payment option engine 144 may store the transaction identifier with a reference to the payment option. Moreover, transaction engine 146 may receive a payment request from payment network backend 160, including the transaction identifier. Payment engine 124 may send a request for payment through normal payment channels to payment network backend 160 that includes the payment amount and the transaction identifier. Payment network backend 160 may forward the request to transaction engine 146 as in a conventional payment request. Payment engine 124 may process the payment and send payment to merchant backend 120 via payment network backend 160.

Payment option engine 144 may query a ledger data store using the transaction identifier as a lookup key, to verify the purchase amount and that the payment has been settled. Payment option engine 144 may then store payment details to be included on the appropriate amount of future invoices and insert the appropriate payment amount on each future invoice according to the terms of the payment option.

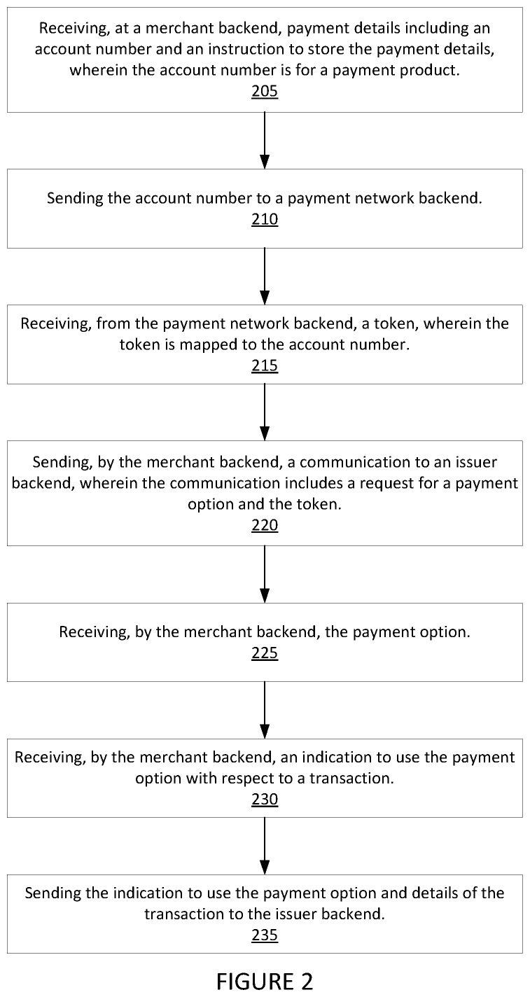

FIG. 2 is a logical flow for secure transmission of payment data, in accordance with aspects.

Step 205 includes receiving, at a merchant backend, payment details including an account number and an instruction to store the payment details, wherein the account number is for a payment product.

Step 210 includes sending the account number to a payment network backend.

Step 215 includes receiving, from the payment network backend, a token, wherein the token is mapped to the account number.

Step 220 includes sending, by the merchant backend, a communication to an issuer backend, wherein the communication includes a request for a payment option and the token.

Step 225 includes receiving, by the merchant backend, the payment option.

Step 230 includes receiving, by the merchant backend, an indication to use the payment option with respect to a transaction.

Step 235 includes sending the indication to use the payment option and details of the transaction to the issuer backend.

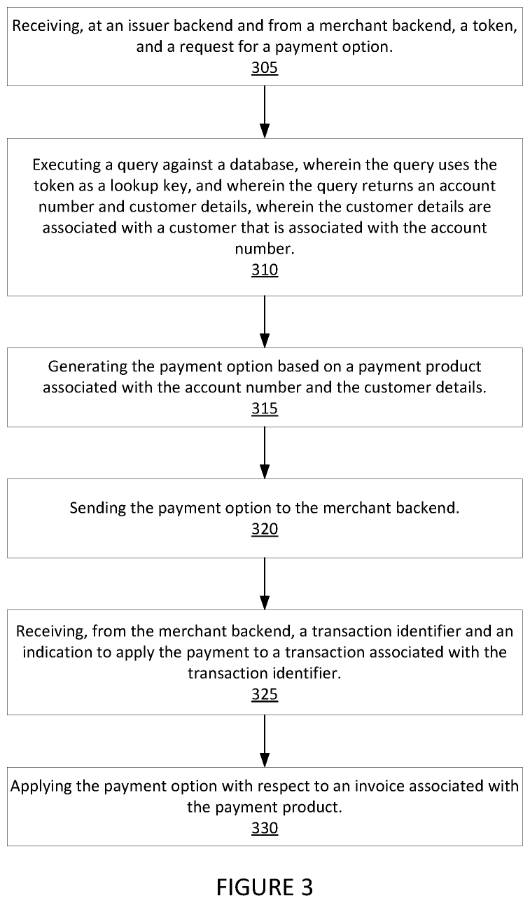

FIG. 3 is a logical flow for secure transmission of payment data, in accordance with aspects.

Step 305 includes receiving, at an issuer backend and from a merchant backend, a token, and a request for a payment option.

Step 310 includes executing a query against a database, wherein the query uses the token as a lookup key, and wherein the query returns an account number and customer details, wherein the customer details are associated with a customer that is associated with the account number.

Step 315 includes generating the payment option based on a payment product associated with the account number and the customer details.

Step 320 includes sending the payment option to the merchant backend.

Step 325 includes receiving, from the merchant backend, a transaction identifier and an indication to apply the payment to a transaction associated with the transaction identifier.

Step 330 includes applying the payment option with respect to an invoice associated with the payment product.

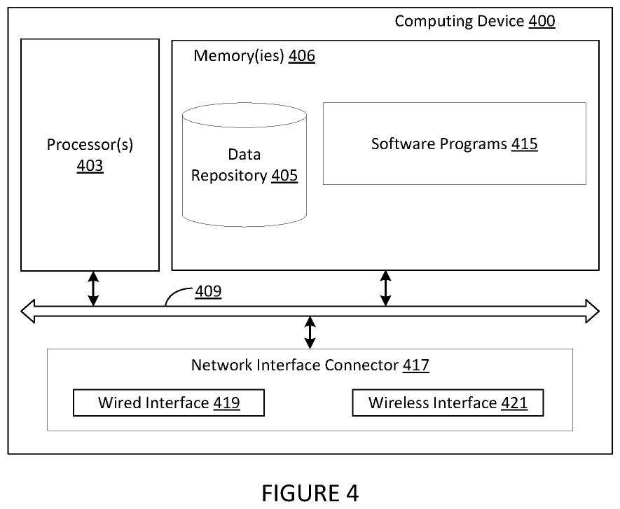

FIG. 4 is a block diagram of a computing device for implementing certain aspects of the present disclosure. FIG. 4 depicts exemplary computing device 400. Computing device 400 may represent hardware that executes the logic that drives the various system components described herein. For example, system components such as a payment engine, a payment option engine, a transaction engine, various database engines and database servers, and other computer applications and logic may include, and/or execute on, components and configurations like, or similar to, computing device 400.

Computing device 400 includes a processor 403 coupled to a memory 406. Memory 406 may include volatile memory and/or persistent memory. The processor 403 executes computer-executable program code stored in memory 406, such as software programs 415. Software programs 415 may include one or more of the logical steps disclosed herein as a programmatic instruction, which can be executed by processor 403. Memory 406 may also include data repository 405, which may be nonvolatile memory for data persistence. The processor 403 and the memory 406 may be coupled by a bus 409. In some examples, the bus 409 may also be coupled to one or more network interface connectors 417, such as wired network interface 419, and/or wireless network interface 421. Computing device 400 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a micro-processor and/or in the form of statically or dynamically programmed electronic circuitry.

The system of the invention or portions of the system of the invention may be in the form of a “processing machine” a “computing device,” or an “electronic device” etc. These may be a general-purpose computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software. In one aspect, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, at a merchant backend, payment details including an account number and an instruction to store the payment details, wherein the account number is for a payment product;
sending, by the merchant backend, the account number to a payment network backend;
receiving, from the payment network backend, a token, wherein the token is mapped to the account number;
sending, by the merchant backend, a communication to an issuer backend, wherein the communication includes a request for a payment option and the token;
receiving, by the merchant backend, the payment option;
receiving, by the merchant backend, an indication to use the payment option with respect to a transaction; and
sending the indication to use the payment option and details of the transaction to the issuer backend.

2. The method of claim 1, comprising:
displaying the payment option via a frontend computer application executing on an electronic device.

3. The method of claim 2, wherein the payment option is selectable by a user of the electronic device.

4. The method of claim 3, wherein the payment option is displayed in association with the transaction.

5. The method of claim 4, wherein the indication to use the payment option with respect to the transaction is received from the electronic device.

6. The method of claim 5, wherein the indication to use the payment option with respect to the transaction is received as a call by the frontend computer application executing on the electronic device to an API method exposed by the merchant backend.

7. The method of claim 6, wherein the indication to use the payment option is received as a parameter of the API method exposed by the merchant backend.

8. A system comprising at least one computer including a processor and a memory, wherein the at least one computer is configured to:
receive payment details including an account number and an instruction to store the payment details, wherein the account number is for a payment product;
send the account number to a payment network backend;
receive, from the payment network backend, a token, wherein the token is mapped to the account number;
send a communication to an issuer backend, wherein the communication includes a request for a payment option and the token;
receive the payment option;
receive an indication to use the payment option with respect to a transaction; and
send the indication to use the payment option and details of the transaction to the issuer backend.

9. The system of claim 8, comprising:
displaying the payment option via a frontend computer application executing on an electronic device.

10. The system of claim 9, wherein the payment option is selectable by a user of the electronic device.

11. The system of claim 10, wherein the payment option is displayed in association with the transaction.

12. The system of claim 11, wherein the indication to use the payment option with respect to the transaction is received from the electronic device.

13. The system of claim 12, wherein the indication to use the payment option with respect to the transaction is received as a call by the frontend computer application executing on the electronic device to an API method exposed by a merchant backend.

14. The system of claim 13, wherein the indication to use the payment option is received as a parameter of the API method exposed by the merchant backend.

15. A non-transitory computer readable storage medium, including instructions stored thereon, which instructions, when read and executed by one or more computer processors, cause the one or more computer processors to perform steps comprising:
receiving, at a merchant backend, payment details including an account number and an instruction to store the payment details, wherein the account number is for a payment product;
sending, by the merchant backend, the account number to a payment network backend;
receiving, from the payment network backend, a token, wherein the token is mapped to the account number;
sending, by the merchant backend, a communication to an issuer backend, wherein the communication includes a request for a payment option and the token;
receiving, by the merchant backend, the payment option;
receiving, by the merchant backend, an indication to use the payment option with respect to a transaction; and
sending the indication to use the payment option and details of the transaction to the issuer backend.

16. The non-transitory computer readable storage medium of claim 15, comprising:
displaying the payment option via a frontend computer application executing on an electronic device.

17. The non-transitory computer readable storage medium of claim 16, wherein the payment option is selectable by a user of the electronic device.

18. The non-transitory computer readable storage medium of claim 17, wherein the payment option is displayed in association with the transaction.

19. The non-transitory computer readable storage medium of claim 18, wherein the indication to use the payment option with respect to the transaction is received from the electronic device.

20. The non-transitory computer readable storage medium of claim 19, wherein the indication to use the payment option with respect to the transaction is received as a call by the frontend computer application executing on the electronic device to an API method exposed by the merchant backend; and
wherein the indication to use the payment option is received as a parameter of the API method exposed by the merchant backend.
